(19) United States
(12) Patent Application Publication
(10) Pub. No.: US 2012/0252653 A1
(43) Pub. Date: Oct. 4, 2012

(54) SETTING AGENT ACCELERATOR FOR REFRACTORY MATERIAL

(75) Inventors: Angela Rodrigues-Schroer, Easton, PA (US); Ronald Warren Schmidt, Macungie, PA (US)

(73) Assignee: Specialty Minerals (Michigan) Inc., Bingham Farms, MI (US)

(21) Appl. No.: 13/073,277

(22) Filed: Mar. 28, 2011

(51) Int. Cl. C04B 35/66; C04B 14/00

(52) U.S. Cl. 501/123; 106/461

(57) ABSTRACT

The present invention relates to a setting agent accelerator for use with an ultra-low cement, low cement and regular castable refractory materials and a method of applying the refractory materials using the setting agent accelerator to form a refractory structure or lining. More particularly, the invention is directed to a setting agent accelerator for use with an ultra-low cement , low cement and regular castable refractory material for preserving or maintaining the safety lining and the working lining of refractory structures or linings from mechanical erosion and/or attack by corrosive materials such as those produced during manufacture of cement, lime, metals or metal alloys including acid and basic slags. The setting agent accelerator has a set accelerating amount of sodium nitrate, sodium nitrite or mixtures thereof, calcium hydroxide and water.

### BACKGROUND OF THE INVENTION

The present invention relates to a setting agent accelerator for use with refractory material and a method of applying the refractory material using the setting agent accelerator to form a refractory structure or lining. More particularly, the invention is directed to a setting agent accelerator for use with refractory material for preserving or maintaining refractory structures or linings from mechanical erosion and/or attack by corrosive materials such as those produced during manufacture of metals or metal alloys including acid and basic slags. The refractory linings also are exposed to thermal shock which can cause premature failure of the refractory.

### SUMMARY

The present invention is directed to a setting agent accelerator for use with refractory material and a method of applying the refractory material using the setting agent accelerator to a refractory structure or lining. The refractory material can be applied to a refractory structure such as the working lining of a vessel or ladle. In some embodiments, the refractory material can form a safety lining of a refractory structure. The refractory material is suitable for use for the maintenance of kilns, furnaces, electric arc furnaces, basic oxygen furnaces, and other metallurgical furnaces, vessels or ladles.

In some embodiments, the composition of the setting agent accelerator can be a set accelerating amount of sodium nitrate, sodium nitrite or mixtures thereof and calcium hydroxide.

In some embodiments, the composition of the setting agent accelerator can be from about 30 to 60 weight percent sodium nitrate, sodium nitrite or mixtures thereof and 10 to 30 weight percent calcium hydroxide and 30 to 60 weight percent water.

In some embodiments, the composition of the setting agent accelerator can be from about 30 to 50 weight percent sodium nitrate, sodium nitrite or mixtures thereof and 10 to 30 weight percent calcium hydroxide and 30 to 60 weight percent water.

In some embodiments, the composition of the setting agent accelerator can be from about 35 to 45 weight percent sodium nitrate, sodium nitrite or mixtures thereof and 12 to 18 weight percent calcium hydroxide and 45 to 55 weight percent water.

Alternatively, the present invention can be an admixture of 69 to 75 weight percent sodium nitrate or sodium nitrite or mixtures thereof and 25 to 31 weight percent calcium hydroxide. In order to make the setting agent accelerator, water is added in the proportions described above to provide the present setting agent accelerator.

The present invention can be an admixture of 60 to 80 weight percent sodium nitrate, sodium nitrite or mixtures thereof and 20 to 40 weight percent calcium hydroxide. In order to make the setting agent accelerator, water is added in the proportions described above to provide the present setting agent accelerator. An important aspect of the invention is that each component plays a different role in the final accelerator formula. The sodium nitrate, sodium nitrite or mixtures thereof in the setting agent accelerator promote flocculating and the calcium hydroxide promotes the final setting of the refractory material with which the setting agent accelerator is used.

Another aspect of the invention is that the above described setting agent accelerator can be used as setting agent accelerator for placing refractory material such as an ultra-low cement castable refractory material, a low cement castable refractory material or a regular castable refractory material. An ultra-low cement castable refractory material is defined as alumina and alumino-silicate castable refractories which contain hydraulic-setting cement and which have a total lime (calcium oxide) content of greater than 0.2 to 1.0 weight percent on a calcined basis. A low cement castable refractory material is defined as alumina and alumino-silicate castable refractories which contain hydraulic-setting cement and which have a total lime (calcium oxide) content of greater than 1.0 to 2.5 weight percent on a calcined basis. A regular castable refractory material is defined as alumina and alumino-silicate castable refractories which contain hydraulic-setting cement and which have a total lime (calcium oxide) content of greater than 2.5 weight percent on a calcined basis.

The sodium nitrate, sodium nitrite or mixtures thereof and the calcium hydroxide of the setting agent accelerator can be premixed and added to a refractory product to provide a sprayable, castable, moldable, projectable, pumpable, shotcretable or manually applied admixture which forms a monolithic refractory structure or lining.

The refractory material can be applied by a gunning system. The refractory material can also be applied by spraying, casting, molding, pumping, projecting, shotcreting, or a hybrid of the listed methods. Other manual methods such as pouring with or without tools can be used.

In the method of the invention, application of the refractory material can be applied to provide a layer of refractory material of a thickness of about 1 inch to about 24 inches both prior to exposing as well as after exposing the lining to corrosive materials. Desirably, application of the refractory material is performed prior to initial exposure of the refractory lining to the corrosive materials, and can be repeated after each exposure of the lining to those corrosive materials. Depending on the degree of erosion, corrosion or penetration of corrosive materials into the applied refractory material, the refractory material of the present invention need not be reapplied to the refractory material after every contact of corrosive materials with the refractory material.

Also, the refractory material used with the present setting agent accelerator can be applied as a safety lining to the shell of the refractory structure. Application of the refractory material can be performed while the target refractory structure is at a temperature of about 32 degrees F. to about 2500 degrees F.

### DETAILED DESCRIPTION OF THE INVENTION

The invention will now be described in detail by reference to the following specification and non-limiting examples. Unless otherwise specified, all percentages are by weight and all temperatures are in degrees Fahrenheit.

The setting agent accelerator has a pH of between 11 and 13. Preferably, the setting agent accelerator has a pH of from 12.0 to 12.4. In some embodiments, the setting agent accelerator can have a pH of less than about 12.4.

The setting agent accelerator can be added to a wetted refractory material in an amount of 0.01 weight percent to 5.0 weight percent of the total dry weight of the refractory material. In some embodiments the setting agent accelerator is added to a wetted refractory material in an amount of 0.1 to 3.0 weight percent of the total dry weight of the refractory material.

The components of the setting agent accelerator play different roles in the final setting agent accelerator formula. They must be combined to be effective as a setting agent accelerator and would not work as well separately. The sodium nitrate, sodium nitrite or mixtures thereof promote the initial flocculating, which is a change in the flow consistency of the refractory material and enables the refractory material to adhere to a refractory structure or lining. The refractory lining is still workable for the initial 20 to 50 minutes after being installed. During this period, the refractory lining can have a surface leveled or smoothed out if necessary, by the use of a hand tool such as a trowel. The calcium hydroxide promotes the final setting of the refractory material with which the setting agent accelerator is used and improves the strength prior to the dry out of the refractory lining. Therefore, 20 to 50 minutes after the refractory material installation, the equipment, such as a steel ladle, can be moved if required.

Sodium nitrate, sodium nitrite or mixtures thereof when used by itself as a setting agent accelerator admixture in a refractory material promotes initial flocking but is ineffective at promoting final set of the refractory material. Often when using sodium nitrate, sodium nitrate or mixtures thereof in a setting agent accelerator final set of the refractory material is well in excess of 50 minutes which is uneconomical because it delays the return to service of the vessel. Calcium hydroxide suspensions when used by themselves in a setting agent accelerator admixture in a refractory material are ineffective at promoting flocculation but do provide for an accelerated final set of less than 50 minutes. Without the initial flocculating, the refractory material is unable to adhere to a refractory structure or lining, and consequently, the refractory material is unable to be applied and remain on a vertical wall without sliding down or falling off the wall or to be applied overhead.

The present invention achieves good initial flocking and also promotes final setting of the refractory material in a sufficiently short period of time while providing a period of time of workability of the applied refractory material.

The components of the setting agent accelerator can be combined in the following ways. The calcium hydroxide component can be in the form of an aqueous suspension and can be added to the solid, preferably powdered, sodium nitrate, sodium nitrite or mixtures thereof. The above described powdered sodium nitrate, sodium nitrite or mixture thereof can be added to the calcium hydroxide component which can be in the form of an aqueous suspension. Similarly, the calcium hydroxide component can be in the form of a powder and can be added to the aqueous sodium nitrate, sodium nitrite or mixture thereof.

The composition of the setting agent accelerator can be a set accelerating amount of sodium nitrate, sodium nitrite or mixtures thereof and calcium hydroxide.

Either solid or powdered calcium hydroxide can be added to water and then the sodium nitrate, sodium nitrite or mixture thereof can be added to the water. Similarly, the sodium nitrate, sodium nitrite or mixture thereof can be added to the water and then the powdered or solid calcium hydroxide can be added to the solution of water and sodium nitrate, sodium nitrite or mixtures thereof.

Alternatively, the present invention can be an admixture of 69 to 75 weight percent sodium nitrate or sodium nitrate or mixtures thereof and 25 to 31 weight percent calcium hydroxide. In order to make the setting agent accelerator, water is added in the proportions described above to provide the present setting agent accelerator.

The present invention can be an admixture of 60 to 80 weight percent sodium nitrate, sodium nitrite or mixtures thereof and 20 to 40 weight percent calcium hydroxide. In order to make the setting agent accelerator, water is added in the proportions described above to provide the present setting agent accelerator. The composition of the setting agent accelerator can be from about 30 to 60 weight percent sodium nitrate, sodium nitrite or mixtures thereof and 10 to 30 weight percent calcium hydroxide and 30 to 60 weight percent water.

In some embodiments, the composition of the setting agent accelerator can be from about 30 to 50 weight percent sodium nitrate, sodium nitrite or mixtures thereof and 10 to 30 weight percent calcium hydroxide and 30 to 60 weight percent water. Preferably the composition of the setting agent accelerator can be from about 35 to 45 weight percent sodium nitrate, sodium nitrite or mixtures thereof and 12 to 18 weight percent calcium hydroxide and 45 to 55 weight percent water.

Preferably, solid sodium nitrate or sodium nitrite or mixtures thereof are first dissolved in water preferably at water temperatures between 50 and 95 degrees Celsius and then solid calcium hydroxide is blended into the solution.

The above described setting agent accelerator can be used as setting agent accelerator for placing refractory material such as an ultra-low cement castable refractory material, a low cement castable refractory material or a regular castable refractory material. An ultra-low cement castable refractory material is defined as alumina and alumino-silicate castable refractories which contain hydraulic-setting cement and which have a total lime (calcium oxide) content of greater than 0.2 to 1.0 weight percent on a calcined basis. A low cement castable refractory material is defined as alumina and alumino-silicate castable refractories which contain hydraulic-setting cement and which have a total lime (calcium oxide) content of greater than 1.0 to 2.5 weight percent on a calcined basis. A regular castable refractory material is defined as alumina and alumino-silicate castable refractories which contain hydraulic-setting cement and which have a total lime (calcium oxide) content of greater than 2.5 weight percent on a calcined basis. In some embodiments, the above described setting agent accelerator can be used as a setting agent accelerator for placing regular castable refractory material having a total lime (calcium oxide) content of greater than 2.5 weight percent on a calcined basis and up to 5.0 weight percent on a calcined basis.

The setting agent accelerator can be admixed with a low-cement refractory structure such as alumina such as fused or tabular alumina, zircon, alumina silicates, etc. The setting agent accelerator can be used with a refractory material, preferably a low cement refractory material, having cement such as calcium aluminate cements.

The refractory material can be applied through any gunning system or applied by spraying, gunning, casting, ramming, molding, pumping, projecting, shotcreting, slurry coating, troweling, hot pouring or a hybrid of the listed methods. Other manual methods such as pouring with or without tools can be used. These methods can include dry, such as gunning and wet process shotcreting.

Preferably the setting agent accelerator is added to the refractory material during shotcreting. For example, the refractory material can be pumped through a hose and into a gun or nozzle for applying refractory materials. At the nozzle of the gun the setting agent accelerator can be added to the refractory material thus forming an admixture on a target refractory structure such as a vessel or ladle. The setting agent accelerator permits initial flocculating to take place followed by the final set of the refractory material. It is believed that the sodium nitrate, sodium nitrite or mixtures thereof promote initial flocculation of the refractory material and that the calcium hydroxide promotes the final setting of the refractory material.

In some embodiments, the refractory material forms a working lining of a refractory structure. The working lining refractory material has good slag and erosion resistance.

In some embodiments, the refractory material can form a safety lining of a refractory structure.

The refractory materials for working and safety lining are suitable for use for the maintenance of kilns, furnaces, electric arc furnaces, basic oxygen furnaces, and other metallurgical furnaces, vessels or ladles.

Without further elaboration, it is believed that one skilled in the art can, using the preceding description, utilize the present invention to its fullest extent. The following embodiments are, therefore, to be construed as merely illustrative, and not limitative of the remainder of the disclosure in any way whatsoever.

### EXAMPLE 1

The following example illustrates the use of the present setting agent accelerator to form a low cement refractory material for applying onto a hot or cold refractory structure such as the slag line of a vessel or ladle which was used with a setting agent accelerator of the present invention.

First, powdered sodium nitrate was added to aqueous calcium hydroxide suspension such that the calcium hydroxide was present in the amount of 17 weight percent of the total weight of the setting agent accelerator and the sodium nitrate was present in the amount of 33 weight percent of the total weight of the setting agent accelerator and the balance of the setting agent accelerator was water. To prepare Sample A, the above described setting agent accelerator was mixed with OPTISHOT® 85 which is a low cement refractory material available from Minteq International Inc. of New York, N.Y. OPTISHOT® 85 comprises 65 to 85 weight percent of 90 to 100 weight percent alumina aggregates and 5 to 20 weight percent of 50 to 60 weight percent alumina aggregates, calcined aluminas, fumed silicas and two to six weight percent calcium aluminate cements. In addition, dispersants, retardants and fibers are present.

1.5 weight percent of the above setting agent accelerator relative to the total dry weight of the low cement refractory material was added to the low cement refractory material.

Sample A produced the following results: initial flock occurred within 3 seconds and loses its initial flow meaning that the admixture of the low cement refractory material with the setting agent accelerator does not flow as prior to the addition of the setting agent accelerator. After initial flocking, Sample A had a “play-doh” consistency and was still workable and deformable. Sample A set hard to firm fingernail pressure in ten minutes.

### EXAMPLE 2

The following example illustrates the use of the present setting agent accelerator to form a low cement refractory material for applying onto a hot or cold refractory structure such as the slag line of a vessel or ladle which was used with a setting agent accelerator of the present invention. First, powdered sodium nitrate was added to aqueous calcium hydroxide suspension such that the calcium hydroxide was present in the amount of 12.5 weight percent of the total weight of the setting agent accelerator and the sodium nitrate was present in the amount of 50 weight percent of the total weight of the setting agent accelerator and the balance of the setting agent accelerator was water. To prepare Sample B, the above described setting agent accelerator was mixed with OPTISHOT® 85. 0.5 weight percent of the above setting agent accelerator relative to the total dry weight of the low cement refractory material was added to the low cement refractory material.

Sample B produces the following results: initial flocking occurred within 5 seconds and loses its initial flow meaning that the admixture of the low cement refractory material with the setting agent accelerator does not flow as prior to the addition of the setting agent accelerator. After initial flocking, Sample B had a “play-doh” consistency and was still workable and deformable. Sample B also exhibited good final set in thirty minutes meaning that the material was not deformable to firm fingernail pressure within thirty minutes.

### EXAMPLE 3

The following example illustrates the use of the present setting agent accelerator to form a low cement refractory material for applying onto a hot or cold refractory structure such as the slag line of a vessel or ladle which was used with a setting agent accelerator of the present invention,

First, powdered sodium nitrate was added to aqueous calcium hydroxide suspension such that the calcium hydroxide was present in the amount of 15 weight percent of the total weight of the setting agent accelerator and the sodium nitrate was present in the amount of 40 weight percent of the total weight of the setting agent accelerator and the balance of the setting agent accelerator was water.

To prepare Sample C, the above described setting agent accelerator was mixed with OPTISHOT® 85. 0.5 weight percent of the above setting agent accelerator relative to the total dry weight of the low cement refractory material was added to the low cement refractory material.

Sample C produces the following results: initial flocking occurred within 5 seconds and loses its initial flow meaning that the admixture of the low cement refractory material with the setting agent accelerator does not flow as prior to the addition of the setting agent accelerator. After initial flocking, Sample C has a “play-doh” consistency and was still workable, and deformable. Sample C also exhibited good final set in thirty minutes meaning that the material was not deformable to firm nail fingernail pressure within thirty minutes.

### EXAMPLE 4

The following example illustrates the use of the present setting agent accelerator to form a low cement refractory material for applying onto a hot or cold refractory structure such as the slag line of a vessel or ladle which was used with a setting agent accelerator of the present invention.

First, powdered sodium nitrite was added to aqueous calcium hydroxide suspension such that the calcium hydroxide was present in the amount of 12.5 weight percent of the total weight of the setting agent accelerator and the sodium nitrite was present in the amount of 50 weight percent of the total weight of the setting agent accelerator and the balance of the setting agent accelerator was water. To prepare Sample D, the above described setting agent accelerator was mixed with OPTISHOT® 85. 0.5 weight percent of the above setting agent accelerator relative to the total dry weight of the low cement refractory material was added to the low cement refractory material.

Sample D produces the following results: initial flocking occurred within 5 seconds and loses its initial flow meaning that the admixture of the low cement refractory material with the setting agent accelerator does not flow—as prior to the addition of the setting agent accelerator. After initial flocking, Sample D has a “play-doh” consistency and was still workable, deformable. Sample D also exhibited good final set in thirty minutes meaning that the material was not deformable to firm fingernail pressure within thirty minutes.

### EXAMPLE 5

The following example illustrates the use of the present setting agent accelerator to form a low cement refractory material for applying onto a hot or cold refractory structure such as the slag line of a vessel or ladle which was used with a setting agent accelerator of the present invention.

First, powdered sodium nitrate was added to aqueous calcium hydroxide suspension such that the calcium hydroxide was present in the amount of 12.5 weight percent of the total weight of the setting agent accelerator and the sodium nitrate was present in the amount of 50 weight percent of the total weight of the setting agent accelerator and the balance of the setting agent accelerator was water.

To prepare Sample E, the above described setting agent accelerator was mixed with OPTISHOT® 60 which is a low cement refractory material available from Minteq International Inc. of New York, New York. OPTISHOT® 60 comprises 55 to 75 weight percent of 50 to 60 weight percent alumina aggregates, 10 to 20 weight percent of 80 to 90 weight percent alumina aggregates, calcined aluminas, fumed silicas and two to six weight percent calcium aluminate cements. In addition, dispersants, retardants and fibers are present.

0.5 weight percent of the above setting agent accelerator relative to the total dry weight of the low cement refractory material was added to the low cement refractory material.

Sample E produces the following results: initial flocking occurred within 3 seconds and loses its initial flow meaning that the admixture of the low cement refractory material with the setting agent accelerator does not flow as prior to the addition of the setting agent accelerator. After initial flocking, Sample E has a “play-doh” consistency and was still workable, deformable. Sample E also exhibited good final set in twenty minutes meaning that the material was not deformable to firm finger pressure within twenty minutes.

The above described setting agent accelerator can be used with OPTISHOT® AZS which is a low cement refractory material available from Minteq International Inc. of New York, N.Y. OPTISHOT® AZS comprises 30 to 60 weight percent of 80 to 90 weight percent alumina aggregates, 20 to 40 weight percent of zircon sand and flours, 5 to 20 weight percent of 50 to 60 weight percent alumina aggregate, 5 to 20 weight percent of calcined and tabular aluminas, fumed silicas and two to eight weight percent calcium aluminate cements. In addition, dispersants, retardants and fibers are present.

### EXAMPLE 6

The following example illustrates the use of the present setting agent accelerator to form a regular castable refractory material for applying onto a hot or cold refractory structure such as safety lining of a vessel or ladle or a working lining of (catalytic cracking systems, coking systems or fireproofing) which was used with a setting agent accelerator of the present invention.

First, powdered sodium nitrate was added to aqueous calcium hydroxide suspension such that the calcium hydroxide was present in the amount of 17 weight percent of the total weight of the setting agent accelerator and the sodium nitrate was present in the amount of 43 weight percent of the total weight of the setting agent accelerator and the balance of the setting agent accelerator was water.

To prepare Sample F, the above described setting agent accelerator was mixed with INSULSHOT™ FH which is a low cement refractory material available from Minteq International Inc. of New York, N.Y. INSULSHOT™ FH comprises 20 to 50 weight percent of 40 to 50 weight percent alumina aggregates, 15 to 25 weight percent of ceramic spheres, 12 to 18 weight percent fumed silicas, 12 tol 8 weight percent calcium aluminate cements, 5 to 15 weight percent silica aggregate, and 5 to 15 weight percent pyrophillite. In addition, dispersants, retardants and fibers are present.

The refractory material used in Example 6 can be considered a regular castable refractory material because the castable refractory material has a total lime (calcium oxide) content of 4.5 weight percent. As set forth earlier, regular castable refractory materials have a total lime (calcium oxide) content of greater than 2.5 weight percent on a calcined basis.

1.35 weight percent of the above setting agent accelerator relative to the total dry weight of the regular castable refractory material was added to the INSULSHOT™ FH regular castable refractory material during a shotcrete installation.

Sample F produces the following results: initial flocking occurred within seconds and loses its initial flow meaning that the admixture of the regular cement refractory material with the setting agent accelerator does not flow as prior to the addition of the setting agent accelerator. After initial flocking, Sample F has a thicker, more viscous consistency and was still workable, deformable. Sample F also exhibited good final set in fifty minutes meaning that the material was not deformable to firm finger pressure within fifty minutes.

### EXAMPLE 7

The following example illustrates the use of the present setting agent accelerator to form an ultra-low cement refractory material for applying onto a hot or cold refractory structure such as the slag line of a vessel or ladle which was used with a setting agent accelerator of the present invention. First, powdered sodium nitrate was added to aqueous calcium hydroxide suspension such that the calcium hydroxide was present in the amount of 14.7 weight percent of the total weight of the setting agent accelerator and the sodium nitrate was present in the amount of 37.8 weight percent of the total weight of the setting agent accelerator and the balance of the setting agent accelerator was water. To prepare Sample G, the above described setting agent accelerator was mixed with OPTISHOT® 90 ULC. 0.5 weight percent of the above setting agent accelerator relative to the total dry weight of the ultra-low cement refractory material was added to the ultra-low cement refractory material. OPTISHOT® 90 ULC comprises 65 to 85 weight percent of 90 to 100 weight percent alumina aggregates and 8 to 15 weight percent of calcined aluminas, fumed silicas and one to three and a half weight percent calcium aluminate cements. In addition, dispersants, retardants and fibers are present.

Sample G produces the following results: initial flocking occurred within 4 seconds and loses its initial flow meaning that the admixture of the low cement refractory material with the setting agent accelerator does not flow as prior to the addition of the setting agent accelerator. After initial flocking, Sample G had a “play-doh” consistency and was still workable and deformable. Sample G also exhibited good final set in twenty minutes meaning that the material was not deformable to firm fingernail pressure within twenty minutes.

Accordingly, it is understood that the above description of the present invention is susceptible to considerable modifications, changes and adaptations by those skilled in the art, and that such modifications, changes and adaptations are intended to be considered within the scope of the present invention.

We claim:

1. A setting agent accelerator for reducing the set time of a castable refractory comprising:
a first component from the group consisting of a set accelerating amount of sodium nitrate, sodium nitrite and mixtures thereof;
calcium hydroxide; and
water.

2. The setting agent accelerator for reducing the set time of a castable refractory of claim 1 wherein the first component is sodium nitrate.

3. The setting agent accelerator for reducing the set time of a castable refractory of claim 1 wherein the first component is sodium nitrite.

4. The setting agent accelerator for reducing the set time of a castable refractory of claim 1 wherein the first component is a mixture of sodium nitrate and sodium nitrite.

5. The setting agent accelerator for reducing the set time of a castable refractory of claim 1 wherein:
the first component is present in an amount from 30 to 60 weight percent;
and the calcium hydroxide is present in the amount of 10 to 30 weight percent;
and water is present in the amount of 30 to 60 weight percent.

6. The setting agent accelerator for reducing the set time of a castable refractory of claim 1 wherein the
first component is present in an amount of from 35 to 45 weight percent;
and the calcium hydroxide is present in the amount of from 12 to 18 weight percent;
and water is present in the amount of from 45 to 55 weight percent.

7. The setting agent accelerator for reducing the set time of a castable refractory of claim 1 wherein the pH of the setting agent accelerator is from 11 to 13.

8. The setting agent accelerator for reducing the set time of a castable refractory of claim 5 wherein the pH of the setting agent accelerator is less than 12.4

9. A process for placing a castable refractory comprising the steps of:
providing a first composition comprising a castable refractory;
forming an admixture by admixing the first composition with a second composition comprising a setting agent accelerator comprising a first component from the group consisting of a set accelerating amount of sodium nitrate, sodium nitrite and mixtures thereof present in an amount from 30 to 60 weight percent of the second composition,
calcium hydroxide present in the amount of 10 to 30 weight percent of the second composition,
and water present in the amount of 30 to 60 weight percent of the second composition, such that the such that when the admixture is made the setting agent accelerator promotes initial flocculating of the castable refractory ;
projecting the admixture onto a metallurgical vessel or kiln;
permitting the setting agent accelerator to achieve final setting of the admixture to set to form a refractory lining.

10. The process for placing a castable refractory according to claim 9 wherein the setting agent accelerator is present in an amount of from 0.1 to 3.0 weight percent of the total dry weight of the admixture.

11. The process for placing a castable refractory according to claim 9 wherein the setting agent accelerator is present in an amount of from 0.01 to 5.0 weight percent of the total wetted weight of the admixture.

12. The process for placing a castable refractory according to claim 9 wherein the first component comprises sodium nitrate wherein the sodium nitrate is present in an amount of from 35 to 45 weight percent of the second composition.

13. The process for placing a castable refractory according to claim 12 wherein the calcium hydroxide is present in an amount of 12 to 18 weight percent of the second composition,

14. The process for placing a castable refractory according to claim 9 wherein the first component comprises sodium nitrite.

15. The process for placing a castable refractory of claim 9 wherein the castable refractory is an ultra-low cement castable refractory,

16. The process for placing a castable refractory of claim 9 wherein the castable refractory is a low cement castable refractory.

17. The process for placing a castable refractory of claim 9 wherein the castable refractory is a regular castable refractory.

18. A refractory composition comprising an admixture of a first composition comprising
a castable refractory;
a second composition comprising a setting agent accelerator comprising a first component from the group consisting of a set accelerating amount of sodium nitrate, sodium nitrite and mixtures thereof present in an amount from 30 to 60 weight percent of the second composition,
calcium hydroxide present in the amount of 10 to 30 weight percent of the second composition,
and water present in the amount of 30 to 60 weight percent of the second composition, such that when the admixture is made the setting agent accelerator promotes initial flocculating and later promotes final setting of the castable refractory.

19. The refractory composition according to claim 18 wherein the setting agent accelerator is present in an amount of from 0.1 to 3.0 weight percent of the total dry weight of the refractory composition.

20. The refractory composition according to claim 18 wherein the setting agent accelerator is present in an amount of from 0.01 to 5.0 weight percent of the total dry weight of the refractory composition.

21. The refractory composition according to claim 18 wherein the first component comprises sodium nitrate wherein the sodium nitrate is present in an amount of from 35 to 45 weight percent of the second composition.

22. The refractory composition according to claim 21 wherein the calcium hydroxide is present in an amount of 12 to 18 weight percent of the second composition.

23. The refractory composition according to claim 18 wherein the first component comprises sodium nitrite.

24. The refractory composition according to claim 18 wherein the refractory castable is an ultra-low cement refractory castable.

25. The refractory composition according to claim 18 wherein the refractory castable is a low cement refractory castable.

26. The refractory composition according to claim 18 wherein the refractory castable is a regular refractory castable.

27. An admixture for a setting agent accelerator for a refractory castable comprising: 60 to 80 weight percent sodium nitrate, sodium nitrite or mixtures thereof and 20 to 40 weight percent calcium hydroxide.

28. The admixture for a setting agent accelerator for a refractory castable of claim 20 comprising 69 to 75 weight percent sodium nitrate, sodium nitrite or mixtures thereof and 25 to 31 weight percent calcium hydroxide.
